(19) United States
(12) Patent Application Publication
(10) Pub. No.: US 2009/0135601 A1
(43) Pub. Date: May 28, 2009

(54) Focusing apparatus with deflection for electromagnetic radiation

(75) Inventors: Ulrich Laudien, Berlin (DE); Silke Settegast, Berlin (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Aktiengesellschaft

(21) Appl. No.: 12/313,577

(22) Filed: Nov. 21, 2008

(30) Foreign Application Priority Data
Nov. 28, 2007 (EP) 07023065.1

(51) Int. Cl. G02B 27/00

(52) U.S. Cl. 362/259

(57) ABSTRACT

It is often not possible to use a rectilinear beam guidance for laser processing in the case of curved components, since the laser and the associated optics are often excessively large. Consequently, according to the invention, a focusing apparatus with beam deflection is proposed that reduces the relevant beam region by means of appropriate lenses and mirror such that it is possible to feed to relatively small locations.

### CROSS REFERENCE TO RELATED APPLICATIONS

This application claims the benefits of European application No. 07023065.1 filed Nov. 28, 2007 and is incorporated by reference herein in its entirety.

### FIELD OF INVENTION

The invention relates to a focusing apparatus for electromagnetic waves.

### BACKGROUND OF THE INVENTION

Electromagnetic waves such as laser beams are often used in order to process metal, ceramic components or layer systems.

In this case, the laser beam is guided in various ways onto the surface of the component to be processed. Difficulties in guiding the laser beam onto the relevant location at a specific angle can occur for processing locations that are difficult to access, such as excessively strongly curved surfaces, for example, because of the size of the laser apparatus.

### SUMMARY OF INVENTION

It is therefore an object of the invention to indicate a focusing apparatus for electromagnetic waves with the aid of which the above-mentioned problem is solved.

The object is achieved by a focusing apparatus having beam deflection as claimed in the claims.

The subclaims list further advantageous measures that can, in turn, be combined at will with one another in order to attain further advantages.

### BRIEF DESCRIPTION OF THE DRAWINGS

In the drawings:

FIG. 1 shows a lens arrangement according to the prior art,

FIG. 2 shows a schematic of the inventive arrangement,

FIG. 3 shows a schematic of the division of the focal length,

FIG. 4 shows an exemplary embodiment of the inventive focusing apparatus with beam deflection,

FIG. 5 shows a gas turbine,

FIG. 6 shows a turbine blade in perspective, and

FIG. 7 shows a list of superalloys.

### DETAILED DESCRIPTION OF INVENTION

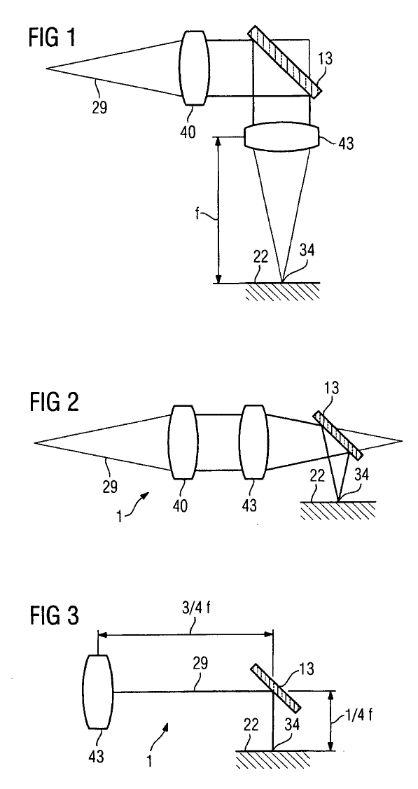

FIG. 1 illustrates an arrangement of lenses 40, 43 and mirror 13 from the prior art.

The laser beams 29 or, in general electromagnetic beams 29 strike a collimator lens 40 and, subsequently, a mirror 13, the result being that the laser beams 29 are deflected onto a focusing lens 43 that has a focal length f and in the case of which a focal point lies at a processing location 34 on a substrate 22.

The inventive design for a focusing apparatus 1 is illustrated schematically in FIG. 2.

The principle can be applied to all types of electromagnetic radiation such as, for example, laser beams, X-radiation or else electron beams.

The focusing device 1 is explained with the aid of laser beams 29 merely by way of example.

The laser beams 29 strike the collimator lens 40 and thereafter the focusing lens 43, a mirror 13 being arranged downstream of the focusing lens 43, that is to say preferably in the beam path between focusing lens 43 and substrate 22, and directs the laser beams 29 onto the processing location 34 of the substrate 22.

The mirror 13 is used for a deflecting device 13 merely by way of example.

A preferred division of the focal length f of the focusing lens 43 is illustrated schematically in FIG. 3.

The focal length f is divided into the distance of the focusing lens 43 from the mirror 13, and from the mirror 13 to the surface of the component 22.

The numerical values ¾ and ¼ are merely exemplary.

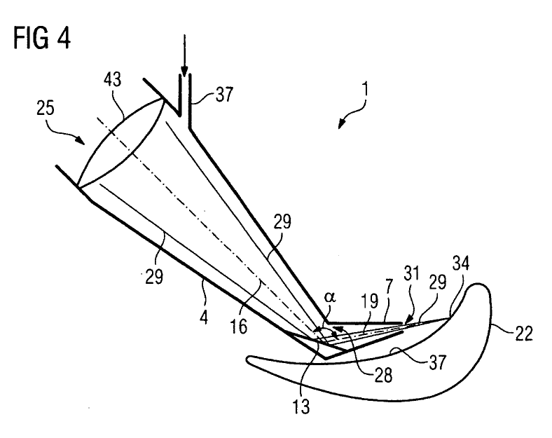

FIG. 4 shows a further focusing apparatus 1 with beam deflection for electromagnetic beams 29.

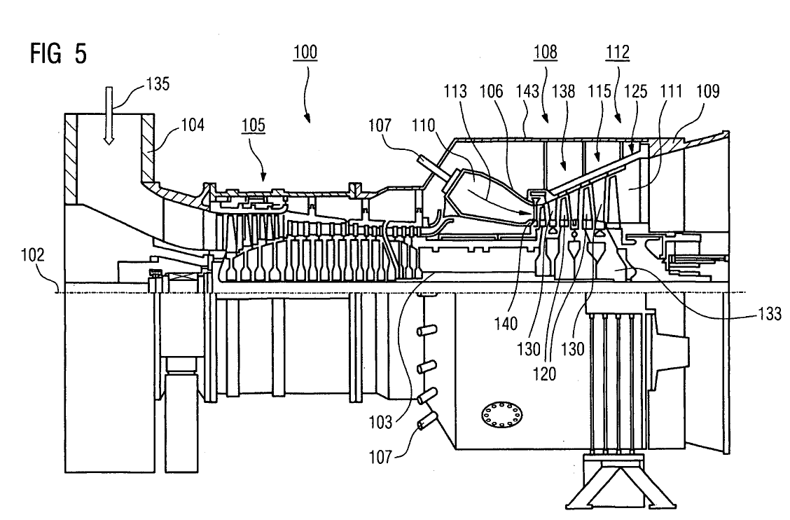

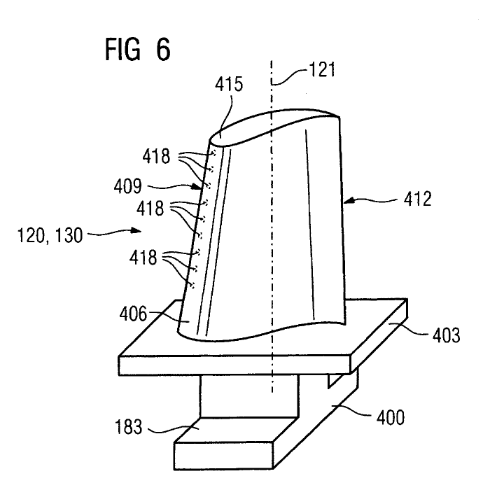

The component 22 to be processed here constitutes by way of example a turbine blade 120, 130 (FIGS. 5, 6) which has a surface 37 curved in such a way that the processing location 34 is not accessible to conventional processing optics.

The focusing apparatus 1 can, however, also process flat surfaces.

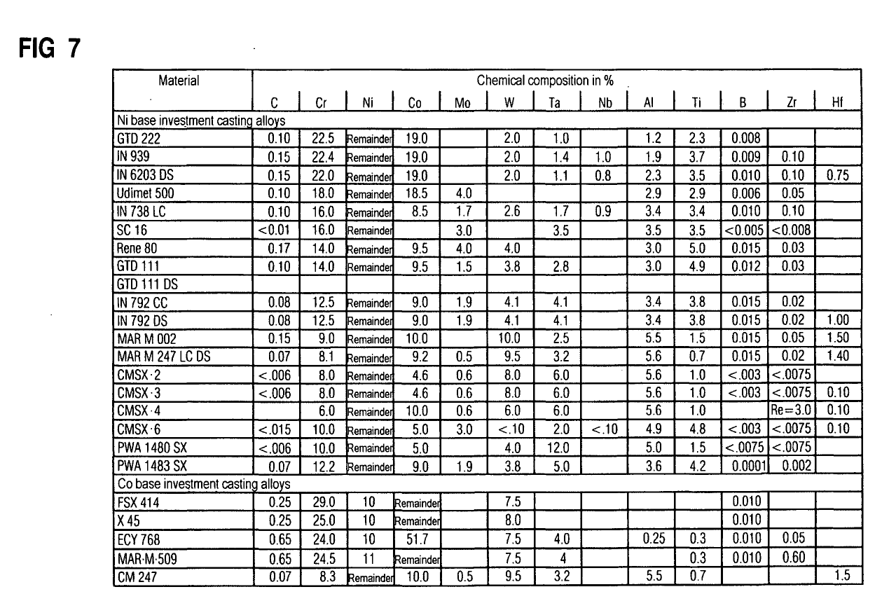

The substrate 22 preferably has a superalloy in accordance with FIG. 7.

It is preferably a layer system composed of a substrate having metal and/or ceramic layers on the substrate 22.

The focusing apparatus 1 preferably has a housing, preferably a first housing 4 and a second housing 7.

The housings 4, 7 are preferably funnel-shaped, in particular of conical design. The invention is explained below with the aid of the funnels 4, 7 merely by way of example.

The first funnel 4 extends along a first longitudinal direction 16.

The ratio of the lengths of the funnels 4, 7 is immaterial, since in accordance with FIG. 3 the focal length f can be divided at will between a fraction between the focusing lens 43 and the mirror 13, and the remaining fraction between the mirror 13 and the component surface (processing location 34).

The second funnel 7 is preferably of smaller, that is to say shorter, design, and preferably of smaller design in the maximum cross section than the first funnel 4. The first and second funnels 7 border one another. A second longitudinal axis 19 of the second funnel 7 extends at an angle α to the first longitudinal axis 29 other than 180°. α is preferably between <180° and 90°.

Mirrors for a beam deflection of 90° are usual in the market.

In the region of an inlet opening of a housing, in particular in a first inlet opening 25 of the first funnel 4, there is preferably present the focusing lens 43, which focuses the incoming laser beams 29 onto a processing location 34 of the component. These laser beams 29 are directed onto a deflecting device 13 for electromagnetic beams, in particular onto a mirror 13.

The deflecting device 13 is located in the housing 4, 7, preferably partly in the first funnel 4 and for the other part in the second funnel 7, which adjoins a first outlet opening 28 of the first funnel 4.

The outlet opening 28 of the first funnel 4 corresponds in cross section to the cross section of the second inlet opening of the second funnel 7.

The focusing lens 43 directs the laser beams 29 onto the mirror 13, from which the laser beams 29 are directed into the region of a second outlet opening 31 of the second funnel 7.

As shown in FIG. 3, it is thereby possible to process a processing location 34 in the region of the curved surface 37 of the component 22. If the longitudinal axis 19 of the second funnel 7 is lengthened, that is to say a central ray of the laser beam 29 that processes the component 22, 120, 130, it would be seen that a trailing edge of the curved component 22 would be cut, and so it would be impossible to process using a rectilinearly guided laser beam.

The second funnel 7 has an outlet opening 31 from which the laser beams 29 emerge and strike the component 22.

Furthermore, the focusing device 1 can have a number of funnels and, if appropriate, correspondingly a number of deflecting devices in order to deflect the laser beams 29 in stepwise fashion. The funnels 4, 7 can be movable relative to one another. In this case, the position of the mirror 13 is preferably also adjusted correspondingly.

The focusing apparatus optionally has a gas feed 37 into the housing, preferably into the funnel 4 or into the funnel 7 downstream of the focusing lens 43, in order to introduce into the funnel 4 or funnel 7 a process gas that strikes the component 22 from a second outlet opening 31 of the second funnel 7, doing so together with the laser beam 29. Air, argon, oxygen or nitrogen, in particular, can be used as process gas.

FIG. 5 shows by way of example a gas turbine 100 in a longitudinal partial section.

In the interior, the gas turbine 100 has a rotor 103 that is rotatably mounted about a rotation axis 102 and has a shaft 101, which is also denoted as a turbine rotor.

Following successively along the rotor 103 are a suction housing 104, a compressor 105, a, for example, toruslike combustion chamber 110, in particular ring combustion chamber, with a number of coaxially arranged burners 107, a turbine 108 and the exhaust gas housing 109.

The ring combustion chamber 110 communicates with a, for example, annular hot gas duct 111. Four turbine stages 112 connected one behind another, for example, form the turbine 108 there.

Each turbine stage 112 is formed, for example, from two blade rings. Seen in the flow direction of a working medium 113, a row 125 formed from rotor blades 120 follows in the hot gas duct 111 of a guide blade row 115.

The guide blades 130 are fastened in this case on an inner housing 138 of a stator 143, whereas the guide blades 120 of a row 125 are fitted by means of a turbine disk 133 on the rotor 103, by way of example.

A generator or a working machine (not illustrated) is coupled to the rotor 103.

During the operation of the gas turbine 100, air 135 is sucked in by the compressor 105 through the suction housing 104 and compressed. The compressed air provided at the turbine-side end of the compressor 105 is guided to the burners 107 and mixed there with a fuel. The mixture is then burned in the combustion chamber 110 while forming the working medium 113. From there, the working medium 113 flows along the hot gas duct 111 past the guide blades 130 and the rotor blades 120. The working medium 113 expands at the rotor blades 120 in an impulse-transmitting fashion such that the rotor blades 120 drive the rotor 103 and the latter drives the working machine coupled to it.

The components exposed to the hot working medium 113 are subjected to thermal loads during operation of the gas turbine 100. The guide blades 130 and rotor blades 120 of the first turbine stage 112 as seen in the flow direction of the working medium 113, in addition to the heat shield elements lining the ring combustion chamber 110, are subjected to the greatest thermal loading.

In order to withstand the temperatures prevailing there, said guide blades 130 and rotor blades 120 can be cooled by means of a coolant.

Substrates of the components can likewise have a directional structure, that is to say they are monocrystalline (SX structure), or have only longitudinally directed grains (DS structure).

Iron-, nickel- or cobalt-based superalloys, for example, are used as material for the components, in particular for the turbine blades 120, 130 and components of the combustion chamber 110.

Such superalloys are known, for example, from EP 1 204 776 B1, EP 1 306 454, EP 1 319 729 A1, WO 99/67435 or WO 00/44949.

The blades 120, 130 can likewise have coatings against corrosion (MCrAlX; M is at least one element of the group comprising iron (Fe), cobalt (Co), nickel (Ni), while X is an active element and stands for yttrium (Y) and/or silicon, scandium (Sc) and/or at least one element of the rare earths, or hafnium). Such alloys are known from EP 0 486 489 B1, EP 0 786 017B1, EP 0 412 397 B1 or EP 1 306 454 A1.

Furthermore, there can be present on the MCrAlX a thermal insulating layer consisting, for example, of ZrO₂, Y₂O₃—ZrO₂, that is to say it is unstabilized, partially stabilized or completely stabilized by yttrium oxide and/or calcium oxide and/or magnesium oxide. Columnar grains are produced in the thermal insulation layer by means of suitable coating methods such as, for example, electron beam physical vapor deposition (EB-PVD).

The guide blade 130 has a guide blade foot (not represented here) facing the inner housing 138 of the turbine 108, and a guide blade head opposite the guide blade foot. The guide blade head faces the rotor 103 and is fastened on a fastening ring 140 of the stator 143.

FIG. 6 shows a perspective view of a rotor blade 120 or guide blade 130 of a turbomachine that extends along a longitudinal axis 121.

The turbomachine can be a gas turbine of an aircraft or of a power plant for electricity generation, a steam turbine or a compressor.

Along the longitudinal axis 121, the blades 120, 130 successively have a fastening region 400, a blade platform 403 bordering thereon, as well as a blade leaf 406 and a blade tip 415.

The blade 130 can have a further platform (not illustrated) on its blade tip 415 as guide blade 130.

Formed in the fastening region 400 is a blade foot 183 that serves to fasten the rotor blades 120, 130 on a shaft or a disk (not illustrated).

The blade foot 183 is, for example, configured as a hammerhead. Other configurations as fir-tree or swallowtail foot are also possible.

The blades 120, 130 have a leading edge 409 and a trailing edge 412 for a medium that flows past the blade leaf 406.

In the case of conventional blades 120, 130, solid metallic materials, in particular superalloys, are used in all regions 400, 403, 406 of the blades 120, 130.

Such superalloys are known, for example, from EP 1 204 776 B1, EP 1 306 454, EP 1 319 729 A1, WO 99/67435 or WO 00/44949.

The blades 120, 130 can be produced in this case by a casting method, also by means of directional solidification, by a forging method, by a milling method, or by combinations thereof.

Workpieces having a monocrystalline structure or structures are used as components for machines that are exposed in operation to high mechanical, thermal and/or chemical loadings.

Production of such monocrystalline workpieces is performed, for example, by directional solidification from the melt. What are involved here are casting methods in which the liquid metal alloy solidifies to form the monocrystalline structure, that is to say the monocrystalline workpiece, or directionally. In this process, dendritic crystals are aligned along the thermal flow, and form either a columnar crystalline grain structure (columnar, that is to say grains that extend over the entire length of the workpiece and are described here as directionally solidified in accordance with general linguistic usage) or a monocrystalline structure, that is to say the entire workpiece consists of a single crystal. It is necessary in these methods to avoid the transition to the globulitic (polycrystalline) solidification, since transverse and longitudinal grain boundaries necessarily form owing to non-directional growth and nullify the good properties of the directionally solidified or monocrystalline component.

Looking in general at directionally solidified structures, what is meant is both monocrystals, which do not have grain boundaries, or have at most small angle grain boundaries, and columnar crystalline structures that, while having grain boundaries extending in a longitudinal direction, do not have any transverse grain boundaries. In the case of these second named crystalline structures, one also speaks of directionally solidified structures.

Such methods are known from U.S. Pat. No. 6,024,792 and EP 0 892 090 A1.

The blades 120, 130 can likewise have coatings against corrosion or oxidation, for example (MCrAlX; M is at least one element of the group comprising iron (Fe), cobalt (Co) and nickel (Ni), while X is an active element and stands for yttrium (Y) and/or silicon and/or at least one element of the rare earth, or hafnium (Hf)). Such alloys are known from EP 0 486 489 B1, EP 0 786 017 B1, EP 0 412 397 B1 or EP 1 306 454 A1, which are to be part of this disclosure with reference to the chemical composition of the alloy. The density preferably amounts to 95% of the theoretical density.

A protective aluminum oxide layer (TGO=thermal grown oxide layer) is formed on the MCrAlX layer (as intermediate layer or as outermost layer).

The layer composition preferably exhibits Co-30Ni-28Cr-8Al-0, 6Y-0, 7Si or Co-28Ni-24Cr-10Al-0, 6Y. In addition to these cobalt-based protective coatings, use is also preferably made of nickel-based protective layers such as Ni-10Cr-12Al-0, 6Y-3Re or Ni-12Co-21Cr-11Al-0, 4Y-2Re or Ni-25Co-17Cr-10Al-0, 4Y-1, 5Re.

Furthermore, there can be present on the MCrAlX a thermal insulation layer which is preferably the outermost layer and consists, for example, of ZrO₂, Y₂O₃—ZrO₂, that is to say it is unstabilized, partially stabilized or completely stabilized by yttrium oxide and/or calcium oxide and/or magnesium oxide.

The thermal insulation layer covers the entire MCrAlX layer.

Columnar grains are produced in the thermal insulation layer by means of suitable coating methods such as, for example electron beam physical vapor deposition (EB-PVD).

Other coating methods are conceivable, for example atmospheric plasma spraying (APS), LPPS, VPS or CVD. The thermal insulation layer can have grains that are porous and affected by microcracks or macrocracks for the purpose of improved thermal shock resistance. The thermal insulation layer is thus preferably more porous than the MCrAIX layer.

Reprocessing (refurbishment) means that components 120, 130 must, if appropriate, be freed from protective layers after being used (for example by sandblasting). This is followed by removing the corrosion and/or oxidation layers or products. If appropriate, cracks in the component 120, 130 are also repaired. Thereafter, the component 120, 130 is recoated, and the component 120 or 130 is reused.

The blades 120, 130 can be of hollow or solid design. When the blade 120, 130 is to be cooled, it is hollow and, if appropriate, also has film-cooling holes 418 (indicated by dashed lines).

1.-9. (canceled)

10. A laser beam focusing apparatus for processing a substrate at a processing location, comprising:
a laser beam source;
a focusing lens; and
a deflecting device that deflects the laser beam, wherein the deflecting device is arranged in the beam path of the laser beam between a substrate having a processing location and the focusing lens;
a plurality of housings having at least a first housing and a second housing where
the first and second housings house the focusing lens and the deflecting device,
the first housing has a first longitudinal direction and the second housing has a second longitudinal direction,
the housings border one another, and
the longitudinal axes of the first and the second housings extend at an angle other than 180°.

11. The focusing apparatus as claimed in claim 10, wherein the deflecting device for electromagnetic beams, is a mirror arranged in a transition between the first housing and the second housing.

12. The focusing apparatus as claimed in claim 11, wherein the focusing lens is arranged in a first inlet opening of the first housing.

13. The focusing apparatus as claimed in claim 11, wherein a gas feed, through which a process gas is introduced, is arranged downstream of the beam path after the focusing lens.

14. The focusing apparatus as claimed in claim 13, wherein the second housing is of smaller in size than the first housing.

15. The focusing apparatus as claimed in claim 14, wherein the first housing is of funnel-shaped.

16. The focusing apparatus as claimed in claim 15, wherein the second housing is of funnel-shaped.

17. The focusing apparatus as claimed in claim 13, further comprising three or more housings.

18. The focusing apparatus as claimed in claim 17, wherein the housings are adjustable relative to each other.
